(19) United States
(12) Patent Application Publication
(10) Pub. No.: US 2025/0155340 A1
(43) Pub. Date: May 15, 2025

(54) SYSTEM AND METHOD FOR PREPARING MULTIPLE SAMPLES FOR CHEMICAL ANALYSIS USING A COMMON HEAT SOURCE

(71) Applicant: ColdBlock Technologies Inc., Niagara Falls (CA)

(72) Inventors: Ravi Kanipayor, Niagara Falls (CA); Thomas Wong, Niagara Falls (CA); Kirill Pereverzev, Niagara Falls (CA)

(21) Appl. No.: 18/838,921

(22) PCT Filed: Feb. 17, 2023
(86) PCT No.: PCT/CA2023/050207

§ 371 Date: Aug. 15, 2024

Related U.S. Application Data
(60) Provisional application No. 63/314,076, filed on Feb. 25, 2022.

(51) Int. Cl. G01N 1/44; G01N 1/40

(52) U.S. Cl. CPC G01N 1/44; G01N 1/4044

(57) ABSTRACT

An apparatus for preparing samples for chemical analysis. The apparatus includes a housing shaped to receive a plurality of elongated sample containers with crucible portions of the plurality of elongated sample containers arranged in a heating compartment of the housing, and an elongated heating element mounted within the heating compartment to simultaneously heat samples in each of the crucible portions while the plurality of sample containers are received in the housing. The apparatus includes an adjacent reflector having a first reflector surface, the first reflector mounted within the heating compartment with the first reflector surface adjacent the heating element and positioned to reflect radiation that is emitted from the heating element.

### FIELD

The specification relates generally to preparing samples for chemical analysis, and more specifically to digesting multiple samples into liquids for chemical analysis using a common heat source.

### BACKGROUND

The primary objective of the sample preparation process in inorganic chemical analyses is to bring the analytical components of interest (the “analytes”) from solid/semi-solid/suspended liquid matrices into aqueous so as to be analyzed by analytical instruments such as Inductively Coupled Plasma Mass Spectrometer (ICP-MS), Inductively Coupled Plasma Spectrometer (ICP-OES), Atomic Absorption Spectrometer and the like.

The types of samples for preparation prior to analysis include wastewater, sludge, sediments, soils, rocks, foods, powder, industrial and manufactured products, animal and plant tissue, plastics, oils, steel, greases, coal, cements, and paint chips. The areas of analytical applications are also diverse and include environmental, geological, food, agriculture and forestry, pharmaceutical, industrial quality control etc. One common trait among these applications is that in most cases, each sample undergoes sample preparation, before they can be analyzed using analytical equipment.

There are different types of sample preparation procedures for solubilization of the analyte into a liquid medium, generally aqueous. In order to achieve full solubilization, the analyte is completely released from the solid or semi-sloid sample and converted into a form which is readily soluble in the liquid medium. For quantitative results, such sample preparation procedures should also take into consideration volatility and decomposition of the analyte. The following are a few examples of these sample preparation procedures.

Acid digestion is a procedure in which a sample reacts with hot liquid acid or acid mixture resulting in dissolving the sample completely or partially into the liquid medium. Generally, this is carried out in a suitable beaker placed on a hot plate. This procedure uses large volumes of acids, which evaporate and escape into the environment at temperatures used for digestion. For safety reasons, such open-vessel digestion process must be carried out inside large and expensive acid resistance fume hoods with appropriate exhaust scrubbers, in order to vent harmful gaseous emissions and corrosive acid vapors to the atmosphere. The scrubbers are used to minimize the release of corrosive acids into the atmosphere. Unfortunately, the scrubbers produce large volumes of acidified wastewater, which still represents an environmental disposal issue. Conventional acid digestion also has a number of other problems. In particular, digestion can take many hours, requires continuous monitoring, large quantities of acids and is manual and labor intensive. Conventional acid digestion is also prone to element loss, contamination problems and generally has poor precision. It is also difficult to automate and computerize the digestion process on hot plate. The handling of quantities of hot acid also represents a safety issue.

In some laboratories, acid digestions are performed using “hot block” digestion vessels, which are large, heated blocks having a number of openings for receiving test tubes containing samples and acid. While this allows some degree of automation and control, acid digestion in a hot block is still prone to the other disadvantages noted above.

Microwave acid digestion is another sample preparation process whereby a sample and acid are placed into a closed vessel and heated by microwave radiation. Volatile elements are contained within the closed vessel, which can offer better control of exhaust fumes and can reduce environmental impact. Microwave acid digestion also tends to use less acid compared to hot block digestion because the acid is contained within the closed vessel. However, microwave acid digestion still suffers from a number of problems. For example, some samples can take longer to digest in comparison to acid digestion in a beaker or hot block. Furthermore, the pressurized closed vessels can be expensive to make, hard to clean, and difficult to work with. Sample sizes are often limited to 0.2-1.0 grams. Another drawback is that the digestion vessel is often made from Teflon, which limits the maximum digestion temperature to about 245° C., otherwise the Teflon lining might distort or deteriorate and can contaminate the sample. With these limitations, microwave digestion can be hard to automate, expensive, and typically results in low production rates with limited batch capacity. Accordingly, while microwave acid digestion might be appropriate for low volume laboratories that focus on digesting certain difficult samples, the process is less attractive to high volume laboratories, which tend to focus on productivity and costs while analyzing a diverse range of samples.

Apparatus, systems and methods for preparing multiple samples for chemical analysis are described in PCT Patent Application No. WO2018/072023. The system includes a housing having a heating compartment, a cooling compartment spaced apart from the heating compartment, and an insulating region located between the heating compartment and the cooling compartment. Also included is an infrared system including a least one infrared heating tube within the heating compartment for heating a sample within a crucible portion of a sample container while the sample container is received within the housing. The infrared heating tube includes an elongated tube positioned below the crucible portion. The apparatus includes a cooling mechanism for cooling the expansion portion of the sample container while the sample container is received within the housing.

While the apparatus, system and method described in PCT Patent Application No. WO2018/072023 may address the drawbacks identified above in respect of conventional sample preparation processes, further refinements have been made to accommodate multi sample preparation using a common heat source. These refinements and improvements are described below.

### SUMMARY

The following summary is intended to introduce the reader to various aspects of the applicant's teaching, but not to define any invention.

According to some aspects, there is provided an apparatus for preparing samples for chemical analysis, comprising: a housing for housing a plurality of elongated sample containers, each of the sample containers having a crucible portion adjacent a closed end and an expansion portion remote from the closed end, the housing having a plurality of receptacles, each of the receptacles being shaped to receive one of the plurality of elongated sample containers such that the crucible portion of the one of the plurality of elongated sample containers is received in a heating compartment of the housing, the plurality of receptacles arranged in a plurality of rows of receptacles such that the plurality of crucible portions of the plurality of sample containers are arranged in a plurality of rows of crucible portions in the heating compartment when the plurality of sample containers are received in the housing; an elongated heating element mounted within the heating compartment between and along a first row and a second row of the plurality of rows of receptacles such that the elongated heating element is arranged between and along a first row and a second row of the plurality of rows of crucible portions when the plurality of sample containers are received in the housing; and a system of reflectors mounted within the heating compartment and arranged to reflect infrared radiation that is emitted from the elongated heating element away from the crucible portions back towards the crucible portions when the plurality of sample containers are received in the housing.

In some examples, the first row and the second row of the plurality of receptacles are parallel, and the elongated heating element is mounted between the first row and the second row such that a lateral projection of each crucible portion of the first row and the second row passes through the elongated heating element when the plurality of sample containers are received in the housing.

The system of reflectors may include a plurality of adjacent reflectors, each adjacent reflector mounted in the heating compartment with an adjacent reflector surface adjacent the heating element, the plurality of adjacent reflector surfaces positioned facing one another across the elongated heating element.

The plurality of adjacent reflector surfaces may each be generally planar surfaces and may each be elongated reflecting surface extending generally parallel to the elongated heating element and generally perpendicular to longitudinal axes of the plurality of sample containers when the plurality of sample containers are received in the housing.

The system of reflectors may include an opposite reflector with an opposite reflecting surface, the opposite reflector mounted within the heating compartment with the opposite reflecting surface positioned such that when a group of the plurality of crucible portions are received in the heating compartment the opposite reflecting surface is opposite the heating element across the crucible portions of the group and directed at the heating element such that the opposite reflecting surface directs radiation towards a second lateral side of each crucible portion of the group, the second lateral side being opposite a first lateral side directed towards the elongated heating element.

According to some aspects, there is provided an apparatus for preparing samples for chemical analysis, comprising: a housing for housing a plurality of elongated sample containers, each of the sample containers having a crucible portion adjacent a closed end and an expansion portion remote from the closed end, the housing having a plurality of receptacles, each receptacle being shaped to receive one of the plurality of sample containers such that the crucible portion of the one of the plurality of sample containers is received in a heating compartment of the housing, the plurality of receptacles arranged in a plurality of rows of receptacles such that the plurality of crucible portions of the plurality of sample containers are arranged in a plurality of rows of crucible portions in the heating compartment when the plurality of sample containers are received in the housing; an elongated infrared heating element mounted within the heating compartment between and along a first row and a second row of the plurality of rows of receptacles such that the elongated heating element is arranged between and along a first row and a second row of the plurality of rows of crucible portions when the plurality of sample containers are received in the housing; a first adjacent reflector with a first elongated reflecting surface extending generally parallel to the elongated heating element, the first adjacent reflector mounted within the heating compartment with the first reflecting surface directed at the heating element; and a second adjacent reflector with a second elongated reflecting surface extending generally parallel to the elongated heating element, the second adjacent reflector mounted within the heating compartment with the second reflecting surface directed at the heating element and generally facing the first reflecting surface across the heating element.

In some examples, each receptacle is shaped to receive the one of the plurality of sample containers such that the expansion portion is received in a cooling compartment of the housing, the cooling compartment separated from the heating compartment by an insulating region, and the apparatus further comprising a cooling system arranged to cool the expansion portions in the cooling compartment while the plurality of sample containers are received in the housing.

The first reflecting surface and the second reflecting surface may each be generally planar surfaces, and the first and second reflecting surfaces may be generally parallel to one another and each extending generally perpendicular to a longitudinal axis of a sample container of the plurality of sample containers when the sample container is received in the housing.

The longitudinal axis may be generally vertical and the second reflecting surface may be a lower surface and the first reflecting surface may be an upper surface overlying the second reflecting surface.

The first reflector may be a first reflector panel adjacent and spaced from the heating element and the second reflector may be a second reflector panel adjacent and spaced from the heating element, each of the first and second reflector panels mounted in the heating compartment spaced from walls of the heating compartment.

The housing may be shaped to receive the plurality of sample containers in a plurality of rows that each extend generally parallel to the heating element, and the heating element may extend between a first row of the plurality of rows and a second row of the plurality of rows when the plurality of sample containers are received in the housing.

The apparatus may further comprise an opposite reflector with an opposite reflecting surface, the opposite reflector mounted within the heating compartment with the opposite reflecting surface positioned such that, when the plurality of sample containers are received in the heating compartment, the heating element is positioned laterally outward from a first lateral side of each of the crucible portions of a group of sample containers of the plurality of sample containers and extending past each of the crucible portions of the group of sample containers, and the opposite reflecting surface is opposite the heating element across the crucible portions of the group of sample containers and directed at the heating element such that the opposite reflecting surface directs radiation towards a second lateral side of each crucible portion of the group of sample containers, the second lateral side being opposite the first lateral side.

According to some aspects, there is provided an apparatus for preparing samples for chemical analysis, comprising: a housing for housing a plurality of elongated sample containers, each of the sample containers having a crucible portion adjacent a closed distal end and an expansion portion remote from the closed end, the housing having a plurality of receptacles, each receptacle being shaped to receive one of the plurality of sample containers such that the crucible portion of the one of the plurality of sample containers is received in a heating compartment of the housing; an elongated infrared heating element mounted within the heating compartment and arranged to simultaneously heat samples in each of the crucible portions while the plurality of sample containers are received in the housing, the elongated heating element positioned laterally outward from a first lateral side of each of the crucible portions and extending past each of the plurality of crucible portions when the plurality of sample containers are received in the housing; a remote reflector with a remote reflecting surface, the remote reflector mounted within the heating compartment with the remote reflecting surface positioned such that when the plurality of crucible portions are received in the heating compartment the remote reflecting surface is remote from the heating element and adjacent a second lateral side opposite the first lateral side of each crucible portion of the group.

In some examples, each receptacle is shaped to receive the one of the plurality of sample containers such that the expansion portion is received in a cooling compartment of the housing, the cooling compartment separated from the heating compartment by an insulating region, and the apparatus further comprising a cooling system arranged to cool the expansion portions in the cooling compartment while the plurality of sample containers are received in the housing.

The remote reflector may be a remote reflector panel mounted in the heating compartment spaced from the sample container, and spaced from walls of the heating compartment by an insulating gap.

The remote reflecting surface may be a generally planar surface.

The plurality of receptacles may be arranged in a plurality of rows of receptacles such that the plurality of crucible portions of the plurality of sample containers are arranged in a plurality of parallel rows of crucible portions in the heating compartment when the plurality of sample containers are received in the housing with the elongated heating element received between and along the plurality of rows of crucible portions, and the apparatus may include at least two remote reflectors, each remote reflector mounted within the heating compartment with the remote reflecting surface positioned opposite the heating element across the crucible portions of a group of sample containers of the plurality of sample containers and directed at the heating element.

When the plurality of sample containers are received in the housing, the heating element may extend between a first row of the plurality of rows of crucible portions and a second row of the plurality of rows of crucible portions, and the at least two remote reflectors may include a pair of remote reflecting surfaces positioned with the first and second rows extending between the pair of surfaces.

The apparatus may further comprise a pair of adjacent reflectors each with an adjacent reflecting surface, the pair of adjacent reflectors each mounted within the heating compartment with the corresponding adjacent reflecting surface directed at the heating element and positioned facing the other adjacent reflecting surface across the heating element.

The housing may have a vertical axis and the housing may be shaped to receive the plurality of elongated sample containers each in a generally vertical orientation, and the pair of adjacent reflectors may include a lower reflector below the heating element and an upper reflector above the heating element and overlying the lower reflector.

Other aspects and features will become apparent to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is a perspective view of a first apparatus for preparing samples for chemical analysis;

FIG. 2 is a perspective and longitudinal cross sectional view of the apparatus of FIG. 1;

FIG. 3 is a side and longitudinal cross sectional view of the apparatus of FIG. 1;

FIG. 4 is a perspective and transverse cross sectional view of the apparatus of FIG. 1;

FIG. 5 is an end and transvers cross sectional view of the apparatus of FIG. 1;

FIG. 6 is an expanded view of a portion of FIG. 5;

FIG. 7A is a schematic view of a first example heating element;

FIG. 7B is a schematic view of a second example heating element;

FIG. 7C is a schematic view of a third example heating element;

FIG. 7D is a schematic view of a fourth example heating element;

FIG. 7E is a schematic view of a fifth example heating element;

FIG. 7F is a schematic view of a sixth example heating element;

FIG. 8A is a back perspective view of a seventh example heating element;

FIG. 8B is a front perspective view of the heating element of FIG. 8A;

FIG. 9 is a perspective and transverse cross sectional view of a second apparatus for preparing samples for chemical analysis;

FIG. 10 is a side and longitudinal cross sectional view of the apparatus of FIG. 9;

FIG. 11 is a schematic end and transverse cross sectional view of a third apparatus for preparing samples for chemical analysis;

FIG. 12A is a perspective view of a fourth apparatus for preparing samples for chemical analysis; and,

FIG. 12B is an expanded view of a portion of FIG. 12A.

### DETAILED DESCRIPTION

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses described below. It is possible that an apparatus or process described below is not an embodiment of any claimed invention. Any invention disclosed in an apparatus or process described below that is not claimed in this document may be the subject matter of another protective instrument, for example, a continuing patent application, and the applicants, inventors or owners do not intend to abandon, disclaim, or dedicate to the public any such invention by its disclosure in this document.

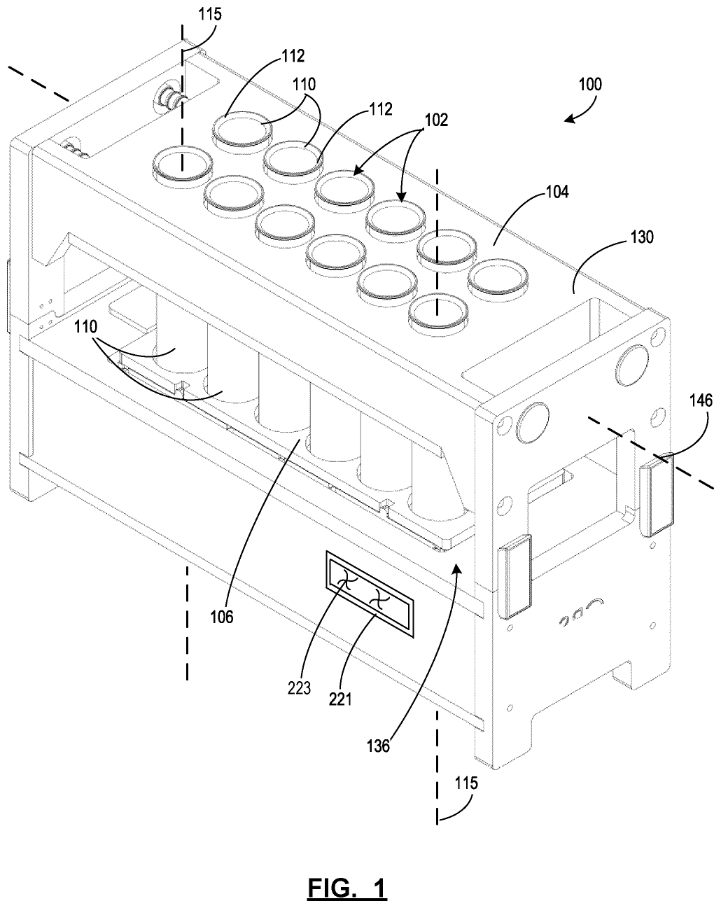

Referring to FIG. 1, an example apparatus 100 for preparing samples for chemical analysis is illustrated. The exemplary apparatus 100 is shaped to receive a plurality of sample containers 110. The exemplary apparatus 100 includes a plurality of receptacles 102. Each receptacle is shaped to receive one of the plurality of sample containers 110. Each receptacle includes walls shaped to hold the sample container 110 in a desired position, such as to hold the plurality of sample containers 110 in rows as illustrated. In the illustrated example, each receptacle 102 includes an opening in an upper plate 104 and an opening in a lower plate 106 with the opening in the upper plate 104 aligned with the opening in the lower plate 106 such that the sample container 110 received in the receptacle is held with an axis 115 of the sample container extending through the upper and lower plates 104, 106. In the illustrated example, the upper and lower plates 104, 106 each include a plurality of openings arranged such that the plurality of receptacles 102 hold the containers 110 in rows.

The sample containers 110 are configured to hold samples to be prepared for chemical analysis. The sample containers 110 are configured to hold liquids in which the samples are to be digested, such as liquid acid. The sample containers 110 may be made from a material that is transparent to radiation generated by the example apparatus 100, as described further below. For example, the sample containers 110 may be formed of a material that is transparent to infrared radiation, such as quartz or borosilicate glass (e.g., Pyrex™ glass). The sample containers 110 may be formed of certain plastics. In some embodiments, cooling of a portion of the sample container at which a sample in the sample container is heated allows the sample container 110 to be made from materials that would otherwise decompose or break-down at temperatures commonly used with hot block or hot plate digestion.

Optionally, the sample container 110 may include one or more graduation markings such as a 25 mL mark, a 50 mL mark, and a 100 mL mark. The marks may assist a technician when adding material such as digestion acid or a liquid for preparing a final volume of sample solution for subsequent chemical analysis.

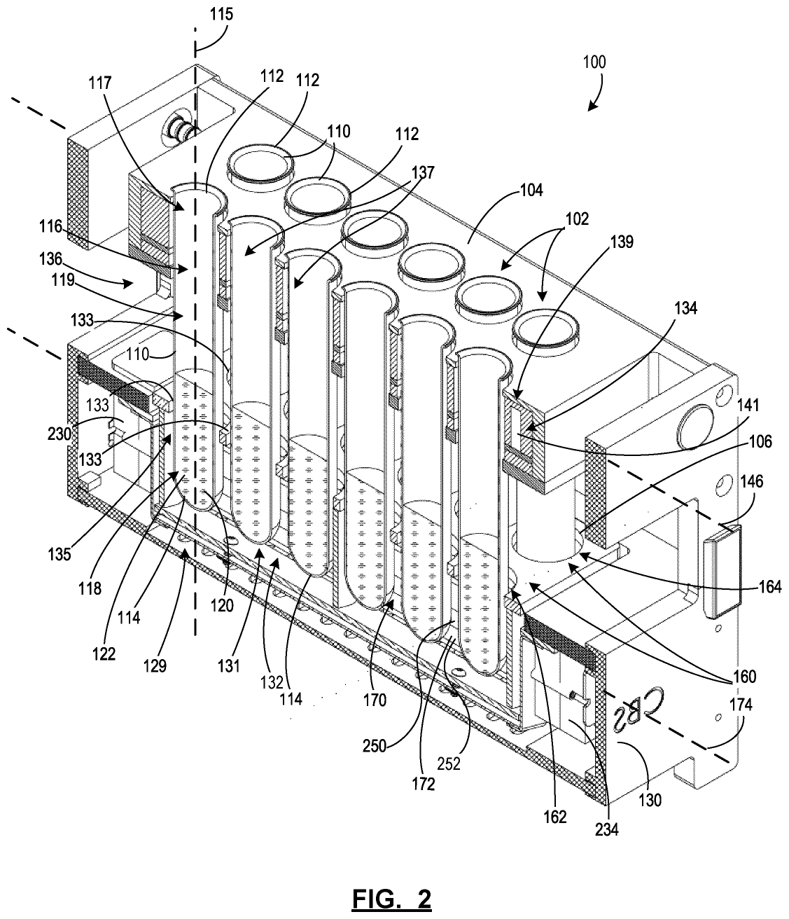

Referring now to FIG. 2, the sample containers 110 may be of various shapes to hold a sample and an acid while the sample is heated to be dissolved in the acid (i.e., any shape with a crucible portion to contain the sample and acid when heated), however the illustrated example sample containers 110 include a heating or crucible portion 118, in which as sample is heated, and an expansion portion 116, in which vapors from the crucible portion 118 may travel. The exemplary expansion portion 116 includes a cooling portion 117, in which vapors are cooled (e.g., actively or passively), and a refluxing portion 119 between the crucible portion 118 and the cooling portion 117. The exemplary sample containers 110 are elongated sample containers with an open end and a closed end.

Each exemplary sample container 110 is an elongated container having a first end 112 and a second end 114. The exemplary first ends 112 are open ends (e.g., to allow a user to add or remove material from the sample container) while the exemplary second ends 114 are closed ends to hold material (e.g., liquid acid). The first ends 112 may be blocked or partially blocked during sample digestion, such as by a plug. For example, a removeable stopper may be loosely placed in the open end to close the open end or partially close the open end (e.g., to allow a slow escape of gases). Closing the open end may pressurize the sample container 110 which may increase the boiling point of an acid or other liquid to reduce vaporization and allow for more energy input to be used.

Each sample container 110 includes a longitudinal axis 115 extending between an expansion portion 116 and a crucible portion 118. The crucible portion 118 is adjacent the closed second end 114. In the exemplary embodiment, the expansion portion 116 is adjacent the open first end 112 and remote from the crucible portion 118.

In the illustrated example, the crucible portion 118 forms a zone where the sample 120 can be heated for digestion, dissolution, or other preparation for chemical analysis. As illustrated in FIG. 2, the crucible portion 118 can hold the sample 120 and liquid acid 122. The sample 120 may be subjected to heating while in the crucible portion 118 in the apparatus 100, such that the sample 120 is digested by the acid 122 and dissolves into the acid 122. The expansion portion 116 is configured to accommodate the vapor produced, and the sample container 110 may optionally be open or partially open at the first end 112 at which the expansion portion 116 is provided, as discussed above, to permit vapor to escape.

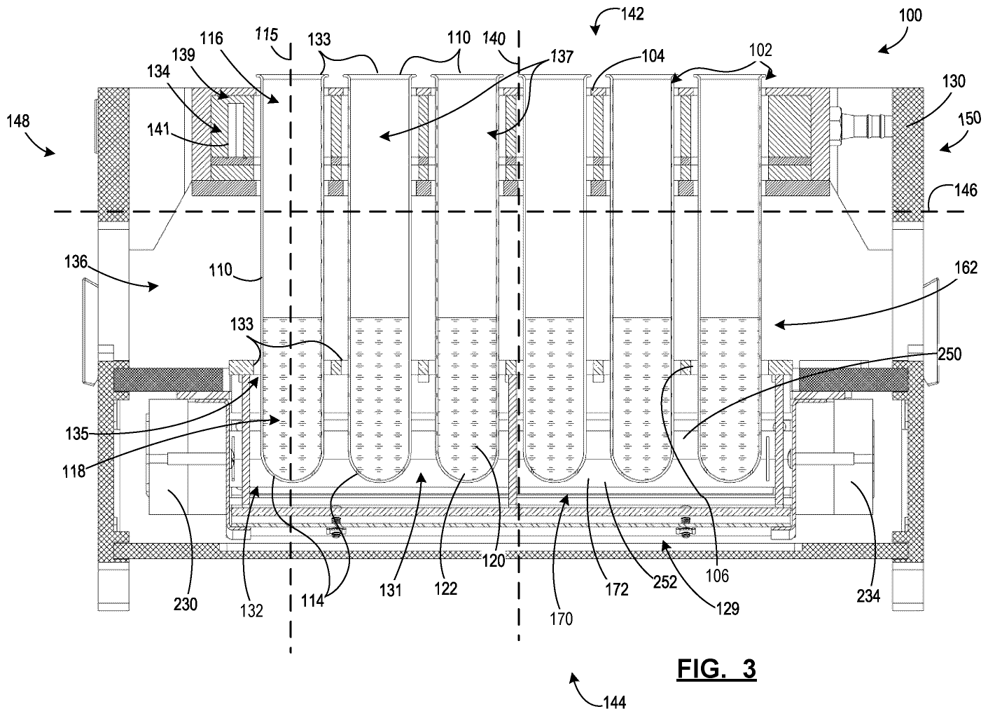

As exemplified in FIGS. 2 and 3, the apparatus 100 for preparing samples for chemical analysis includes a housing 130. The housing 130 includes a heating compartment 132. The housing 130 includes receptacles 102 shaped to receive the plurality of sample containers 110 with the crucible portions 116 in the heating compartment 132. The plurality of sample containers 110 extend into the heating compartment through entrances 133 at an entrance end 135 of the heating compartment 132 (e.g., the upper end, as illustrated). The entrances 133 are openings in a lower plate 106 through which each receptacle 102 extends.

It will be understood that various heating compartment 132 may be used, such as a compartment forming a plurality of chambers each sized to hold only one crucible portion 118 (e.g., with passages between to allow a heating element to extend past several crucible portions 118). However, in the exemplary embodiment the heating compartment 132 includes a single large chamber 131 sized to hold a plurality of crucible portions 118 of a plurality of sample containers 110 (e.g., a plurality of sample containers 110 arranged in a plurality of rows). A large chamber may allow for, e.g., a simplified construction of the heating compartment 132. An insulating gap 129 may extend between the heating compartment 132 and the outer walls of the housing 130. For example, the gap 129 may extend between the heating compartment 132 and a bottom panel 109 of the housing 130, lateral walls of the housing 130, and/or end walls of the housing 130.

As illustrated, the sample containers 110 may be arranged in the heating compartment with the second ends 114 of the sample containers 110 spaced from the walls of the heating compartment 132. In the illustrated example, the second ends 114 are spaced from the lateral walls and the floor of the heating compartment to allow for fluid movement between the sample container and the walls of the heating compartment 132. For example, acid may run down from the open first end 112 to the second end of a sample container 110, and drip from the sample container 110 to be collected (e.g., in the housing 130 or in a separate container if the housing 130 is open to allow liquid to flow out). The entrances 133 may each be sized to allow for a gap between the sample container 110 and the wall of the heating compartment 132 (e.g., the ceiling panel or plate 106, as illustrated) in which the entrances 133 are formed, such as to allow liquid to pass through the entrances 133 past the sample containers 110.

The apparatus 100 may be configured to use energy in cooling vapour in the expansion portion 116 (i.e., in the cooling portion 117), or the apparatus 100 may be configured to not use energy in cooling vapour. In other words, the apparatus 100 may include active cooling or passive cooling.

In some examples, the apparatus 100 includes active cooling, and includes a cooling compartment 134 (e.g., holding the cooling portion 119). It will be understood that in some embodiments, the housing 130 may not include a cooling compartment, such as if vapors are released from the sample containers 110 and/or vapors are condensed within the sample containers 110 without being in a cooling compartment of the housing (e.g., the expansion portion 116 may be outside the heating compartment but not in a cooling compartment of the apparatus 100, such as extending into an environment for passive cooling or extending into a cooling compartment of a further apparatus to be actively cooled by the further apparatus).

However, including a cooling compartment in the apparatus 100 may facilitate digestion. For example, a cooling compartment may help minimize loss of vapor by cooling and condensing vapor during digestion if the acid evaporates and rises to the expansion portion 116. In the exemplary embodiment, the housing 130 includes a cooling compartment 134. The exemplary housing 130 is shaped to receive the plurality of sample containers 110 with the expansion portions 116 in the cooling compartment 134.

It will be understood that various cooling compartments 134 may be used, such as an open chamber sized to hold multiple expansion portions 116 simultaneously (e.g., cooled by natural air movement or air movement generated by a fan). However, in the exemplary embodiment the cooling compartment 134 includes a plurality of cooling chambers 137. The exemplary cooling compartment 134 includes a chamber 137 for each sample container 110, with the chambers 137 sized to receive a single sample container 110. The example chambers 137 are similar in size and shape to the upper part of the sample container 110 that is to be received therein. In other words, the chambers 137 each have a volume that is about the same as the volume of the portion of the sample container to be received therein. The chambers 137 may be sized to keep the walls of the sample container close to the walls of the chamber (e.g., to facilitate heat transfer). Optionally, a gap extends between the chamber walls and the portion of the sample container 110 received therein, e.g., for the passage of fluids down an outside of the sample container 110.

The cooling compartment 134 includes a cooling system 139 (i.e., the exemplified apparatus 100 includes active cooling). The cooling system 139 may be any of various cooling systems, and may include, e.g., a fan, a condenser coil, or a thermoelectric device such as a Peltier device. As in the illustrated example, the cooling system 139 may include passages 141 through the cooling compartment 134 to carry fluid coolant (e.g., cold air, or cold water or refrigerant) around the sample containers 110 received in the cooling compartment 134 to cool the portion of the sample containers 110 that is received in the cooling compartment 134. The cooling system 139 may include a pump to circulate the fluid such as cold water or refrigerant, or a fan to circulate air or other gases. The cooling system 139 may be operable to maintain the cooling compartment 134 and/or the expansion portions 116 at a predetermined cooling temperature or within a predetermined range (e.g., within a range of 0-20° C., 5-10° C., less than 5° C., less than 10° C., or less than 0° C.).

Optionally, the cooling system 139 is controlled by a cooling controller. The cooling controller may be operable to control the operation of the cooling system 139 by, e.g., controlling the amount and/or speed of fluid moved by the pump and/or controlling the state of the thermoelectric device.

In the exemplary embodiment, the heating compartment 132 is separated from the cooling compartment 134 by an insulating region 136. The insulating region 136 may also act as an expansion region (e.g., holding the expansion portion 117). The insulating region 136 may include an insulating material in some embodiments, such as one or more panels of insulation arranged in layers. However, in the illustrated example, the insulating region 136 is an open space between the heating compartment 132 and the cooling compartment 134. Optionally, a fan or other air moving device is provided to encourage air flow through the insulating region 136 (e.g., to improve heat dissipation).

The apparatus 100 may be a refluxing apparatus in which liquid in the heating compartment 132 is heated to a boil and vapour travels from the heating compartment 132 to the cooling compartment 134 where it condenses and returns to the heating compartment 132. For example, when sample containers 110 are received in the apparatus 100, liquid acid 122 may be received in the crucible portions 118 in the heating compartment 132 where it may be heated as described below, and vapour from the acid 122 may travel to the expansion portion 116 in the cooling compartment 134 where it condenses, whereupon the vapour travels back to the crucible portion 118 in the heating compartment 132. Vapour traveling through the expansion zone 136 may expand and heat may be dissipated to the environment (e.g., through the walls of the sample containers 110).

As in the illustrated example of FIG. 3, the housing 130 may have a vertical axis 140 extending between an upper end 142 and a lower end 144, and a longitudinal axis 146 extending between a front end 148 and a rear end 150. The cooling compartment 134 may be above the heating compartment 132, such as directly overlying the heating compartment 132 as exemplified. Arranging the cooling compartment 134 above the heating compartment 132 may facilitate the movement of vapour and condensate, though it will be understood that the housing 130 may be arranged in other ways in some embodiments.

It will be understood that while the housing 130 is described with a single heating compartment 132, a single cooling compartment 134, and a single insulating region 136, the housing 130 may alternatively include a plurality of heating compartments 132, a plurality of cooling compartments 134, and/or a plurality of insulating regions 136. For example, the housing 130 may include a single heating compartment receiving a plurality of crucible portions 116, and a plurality of cooling compartments each receiving a subset of the expansion portions 118 corresponding to the crucible portions 116 received in the heating compartment. For example, the crucible portions may be received in a common heating compartment, and optionally a subset of the corresponding sample containers extend out one side of the heating compartment with the expansion portions received in a first cooling compartment while another subset of the sample containers extend out another side of the heating compartment with the expansion portions received in a second cooling compartment.

In some embodiments, as exemplified in FIGS. 2 and 3, the housing 130 is shaped to receive the crucible portions 118 of the plurality of elongated sample containers 110 arranged in a plurality of rows 160 in the heating compartment 132. The illustrated example includes a first row 162 and a second row 164. The rows 160 may be parallel rows. The sample containers 110 may be arranged with the axes 115 generally parallel to one another. As exemplified, the second ends 114 may be generally coplanar when the sample containers 110 are received in the housing 130. The illustrated embodiment can receive 12 sample containers in two rows, however other housings may receive more or less sample containers and/or in more or less rows (e.g., 18 or 24 sample containers in 3 by 6 or 4 by 6 configurations).

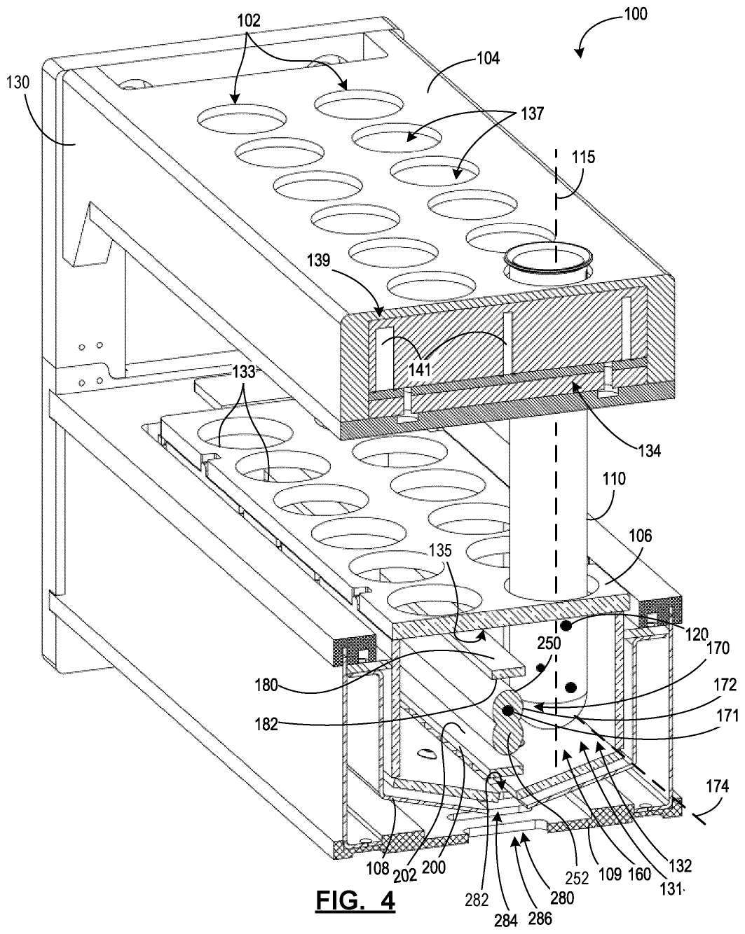

Referring now to FIGS. 4 and 5, the apparatus 100 includes a heating element 170 mounted within the heating compartment 132 to heat the samples 120 received in a sample container 110. The heating element 170 is arranged to simultaneously heat samples 120 in more than one sample container 110.

In some embodiments, the heating element 170 is an infrared heating element operable to emit infrared radiation. The infrared radiation may be selected to be partially or completely transmitted through the sample container 110 and the acid or acid mixture or other sample processing liquid or liquid mixture. Optionally, the infrared radiation may be selected to directly energize the sample 120 without appreciably heating the sample container 110 or the liquid therein. For example, liquid reactants such as acids and other aqueous solutions tend to be more transparent to infrared radiation as compared to microwave radiation, particularly for near infrared and short infrared wavelengths. Accordingly, infrared radiation can offer a greater amount of input radiation energy to energize the sample 120 directly, and thereby initiate chemical transformation of the sample in the presence of the liquid reactant (e.g. the acid or acid mixture). Optionally, excess thermal energy released from transformation of the sample 120 can be removed from the crucible portion 118 by cooling the heating compartment, which may help maintain the temperature of the acid below its boiling point.

The wavelength of the infrared radiation is generally selected to be absorbed by the sample 120 directly so as to energize the sample 120 for reaction with the surrounding acid medium. For example, the infrared radiation may have a wavelength of between about 700 nm and about 1 mm, less than about 3 μm, or less than about 1.4 μm. In some cases, the infrared radiation may have a peak energy at about 1 μm. The infrared radiation may be short-wave infrared (SWIR) light which is typically in the range between 0.7-2.5 μm. This radiation may provide energy directly to the solid samples 120 inside the crucible 118 of the sample container 110 without generally being absorbed by the body of the sample container.

The heating element 170 may include a filament 171 (e.g., a heating coil) which may emit infrared radiation when powered. The filament 171 may be a tungsten or carbon filament. The apparatus 100 may include a power source (e.g., a power cord to receive power from an external source and/or an on-board power supply such as a battery or capacitor) and a heating controller operable to control the supply of power to the heating element 170 (e.g., to the filament 171). For example, the heating controller may be operable to increase, decrease, and/or maintain the radiation output of the heating element 170, such as by controlling a supply of voltage to the filament 171. For example, the heating controller may be operable to power the filament 171 at a predetermined voltage and/or for a predetermined amount of time. The heating controller may be the same controller as the cooling controller, or may be a separate controller.

The filament 171 is held in a chamber of a tube 172, such as a quartz tube. The heating element 170 may also include an electrical box at one or each end of the tube 172. For example, the heating element 170 may have a filament 171 which runs from a first electrical box 230 at one end of the tube 172 to a second electrical box 234 at the other end of the tube 172 through either of a first tube member 250 and a second tube member 252 which is fused to a first tube member 250 to together make up the tube 172 (FIGS. 2 and 3).

In some embodiments, the heating element 170 is operable to emit radiation as a point source. In other words, the heating element 170 is operable to emit radiation in all directions. In some embodiments, the heating element 170 does not include any built-in reflectors to redirect emitted radiation towards one side or sides of the heating element 170. For example, the heating element 170 may include the filament 171 in an elongated tube 172 without any reflectors on or in the elongated tube 172 to restrict the emission directions of the radiation from the filament 171. The resulting heating element 170 may radiate freely in, at least, all lateral directions (i.e., perpendicular to the longitudinal axis 174 shown in FIG. 4).

In the illustrated example, the heating element 170 is an elongated heating element. The heating element 170 includes the elongated heating tube 172 arranged to simultaneously heat samples 120 in each of the plurality of sample containers 110 when the plurality of sample containers 110 are received in the housing 130. The filament 171 of the exemplary embodiment runs the length of the elongated heating tube 172 to emit radiation along the length of the elongated heating tube 172.

As exemplified in FIG. 2, the heating element 170 may be a generally linear elongated heating element to run parallel to generally linear rows of crucible portions 118. The exemplary heating element 170 is arranged between the rows 160. In the exemplary embodiment the heating element 170 is between the first row 162 and the second row 164 and has a longitudinal axis 174 that is generally parallel to the first row 162 and the second row 164. The exemplary heating element 170 is received between the first and second rows 162, 164 and positioned laterally outward from each crucible portion. In other words, a lateral projection of the crucible portion 118 (i.e., a projection perpendicular to the axis 115) would pass through the heating element 170.

Referring again to FIGS. 4 and 5, the heating element 170 may be spaced from a floor of the heating compartment 132 (e.g., to better position the heating element 170 between rows 160). In some examples, the second ends 114 of the sample containers 110 received in the housing 130 may be closer to the floor of the heating compartment than the heating element 170 is and/or may be below the heating element 170 (e.g., the sample containers 110 may be closer to the floor since the floor of the heating compartment is sloped, with a higher portion of the floor under the sample containers 110). As illustrated in FIG. 5, the heating element 170 may be laterally alongside the crucible portion 118 of the sample containers 110 received in the housing 130.

The heating element 170 may be adjacent the sample containers 110 received in the housing 130. In other words, the heating element 170 may be near the sample containers 110 without any other component between the sample containers 110 and the heating element 170. The heating element 170 is spaced from the sample containers 110 received in the housing 130, but may be spaced from the sample container 110 by less than 100%, 50%, or 25% of the width 183 of the heating element 170. Optionally, the heating element 170 extending between first and second rows 162, 164 may be spaced from sample containers 110 in the first row 162 by the same distance as the heating element 170 is spaced from the sample containers 110 in the second row 164.

The apparatus 100 includes a system of reflectors 168 (e.g., with a surface that reflects infrared radiation, such as gold or ceramic reflectors or polished metal surface). The system of reflectors 168 includes reflectors mounted within the heating compartment and arranged to reflect infrared radiation that is emitted from the elongated heating element away from the crucible portions back towards the crucible portions when the plurality of sample containers are received in the housing. The system of reflectors 168 may include one or more adjacent reflector (may also be referred to as primary reflector(s)) and/or one or more remote reflector (may also be referred to as secondary reflector(s)). Each reflector may be mounted in the heating compartment spaced from walls of the heating compartment. Optionally, each reflector includes a reflector panel that is spaced from walls of the heating compartment by an insulating gap. Spacing the reflectors from the walls may allow for more effective reflection. For example, a reflector adjacent to and directly above the heating element may reflect radiation more effectively towards the crucible portions than a reflective ceiling of the heating compartment (e.g., allowing for more targeted reflection while still maintaining the whole crucible portion in the heating compartment). It will be understood that in some embodiments the heating compartment may alternatively or additionally include reflective surfaces on the walls of the heating compartment (e.g., ceiling, floor, and/or lateral walls).

In the exemplary embodiment, the system of reflectors includes an adjacent or primary reflector positioned adjacent the heating element 170. In other words, the adjacent reflector may be positioned near the heating element 170 (e.g., spaced from the heating element 170 by less than 50%, less than 25%, or less than 10% the width 183 of the heating element), without any other component between the heating element 170 and the adjacent reflector.

The exemplary apparatus 100 shown in FIGS. 4 and 5 includes a first adjacent or primary reflector 180 having a first reflector surface 182. The first adjacent reflector 180 is mounted within the heating compartment 132 (i.e., not forming one of the walls of the heating compartment 132), with the first reflector surface 182 adjacent the heating element 170. In other words, the first reflector surface 182 is near the heating element 170 with no other component between the heating element 170 and the first reflector surface 182. The exemplary first reflector surface 182 is spaced from the heating element 170. The first reflector surface 182 is spaced from the heating element 170 by less than 50%, less than 25%, or less than 10% the width 183 of the heating element. The first reflector 180 may be spaced from one or more walls (e.g., ceiling and floor, such as plate 106) of the heating compartment 132, as illustrated.

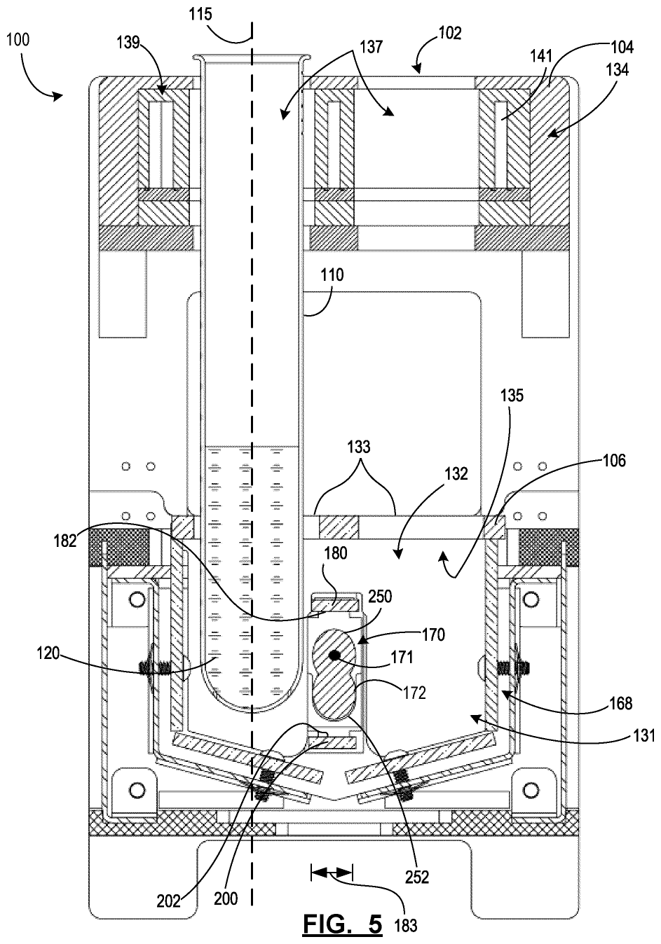

Referring to FIG. 6, the first adjacent reflector 180 may be arranged in various positions to reflect radiation from the heating element 170. The exemplary first reflector surface 182 is positioned to reflect substantially all radiation 184 that is emitted from the heating element 170 in a first direction 186 that is towards the entrance end 135 of the heating compartment 132 and parallel to the longitudinal axes 115 of the sample containers 110. In the exemplary embodiment, the first reflector 180 is positioned to reflect the radiation from the heating element 170 back to the heating element 170, thus re-directing the radiation mostly sideways.

In some embodiments, as illustrated, the first adjacent reflector 180 is positioned with the first reflector surface 182 nearer than the heating element 170 to the entrances 133 and/or entrance end 135 through which the sample containers 110 extend into the heating compartment 132 when the sample containers 110 are received in the housing 130. Positioning the first reflector 180 nearer the entrances 133 and/or entrance end 135 may redirect radiation that is emitted from the heating element 170 towards the entrances 133 and/or entrance end 135 to be better used in heating the samples 120.

In the exemplary embodiment, the first adjacent reflector 180 is part of a plurality of adjacent reflectors 190 (e.g., two exemplified in FIG. 6; reflector 180 and reflector 200) and the first reflecting surface 182 is part of a plurality of reflecting surfaces 192 (e.g., two exemplified in FIG. 6) of the plurality of adjacent reflectors 190. The plurality of adjacent reflectors 190 are each mounted in the heating compartment 132 with the plurality of reflector surfaces 192 adjacent the heating element 170. As exemplified, the plurality of reflector surfaces 192 may be positioned to together reflect substantially all the radiation 184 that is emitted from the heating element 170 parallel to the longitudinal axes 115 of the sample containers 110, including the radiation 184 emitted in the first direction 186 and radiation emitted in a second direction 194 that is away from the entrance end 135 of the heating compartment 132. The plurality of reflectors 190 includes a second adjacent or primary reflector 200 with a second reflecting surface 202 of the plurality of reflecting surfaces 192.

The exemplary second reflecting surface 202 is positioned to reflect substantially all radiation 184 that is emitted from the heating element 170 in the second direction 194. In the exemplary embodiment, the second adjacent reflector 200 is positioned to reflect the radiation from the heating element 170 back to the heating element 170, thus re-directing the radiation mostly sideways. However, similar to the first reflector 180, it will be understood that the second reflector 200 may be arranged in various positions to reflect the radiation 184 of the heating element 170. The second adjacent reflector 200 is mounted within the heating compartment 132 (i.e., not forming one of the walls of the heating compartment 132), with the second reflector surface 202 adjacent the heating element 170. In other words, the second reflector surface 202 is near the heating element 170 with no other component between the heating element 170 and the second reflector surface 202. The exemplary second reflector surface 202 is spaced from the heating element 170. The second reflector surface 202 is spaced from the heating element 170 by less than 50%, less than 25%, or less than 10% the width 183 (e.g., a narrowest width of the tube) of the heating element 170. The second reflector 200 may be spaced from one or more walls (e.g., ceiling and floor, such as plate 106 and floor 108) of the heating compartment 132, as illustrated.

The first reflecting surface 182 may have generally the same length and width as the second reflecting surface 202. The first reflecting surface 182 may be nearer than the second reflecting surface 202 to the entrance 133 to the heating compartment through which the plurality of elongated sample containers extend into the heating compartment when the plurality of sample containers is received in the heating compartment.

In some embodiments, the first reflecting surface 182 is an elongated reflecting surface extending generally parallel to the elongated heating tube 170. In some embodiments, the second reflecting surface 202 is an elongated reflecting surface extending generally parallel to the elongated heating tube 170. The heating element 170 and the first reflecting surface 182 and/or the second reflecting surface 202 may extend parallel to a row 160 and/or between rows 160, with the reflecting surface(s) extending generally the same length along the row(s) 160 as the heating element 170.

In some embodiments, the first reflecting surface 182 and/or second reflecting surface 202 has a width 204 (FIG. 6) that is about the same as the width 183 of the heating element 170 along the same dimension. For example, the first reflecting surface 182 and/or second reflecting surface 202 may have the width 204 that is less than 15%, 10%, or 5% greater or lesser than the width 183 of the heating element 170 along the same dimension.

In some embodiments, as illustrated, the second adjacent reflector 200 is mounted within the heating compartment 132 with the second reflecting surface 202 directed at the heating tube 170 and generally facing the first reflecting surface 182 across the heating tube 170. The first and second reflecting surfaces 182, 202 may sandwich the heating element 170 between them. The first and second reflecting surfaces 182, 202 may be above and below the heating element 170, as illustrated, and the first reflecting surface 182 may overly the second reflecting surface 202.

While the reflecting surfaces 192 may be of various shapes, in some embodiments the reflecting surfaces 192 may each be generally planar surfaces, as illustrated. The reflecting surfaces 192 may each be generally perpendicular to the longitudinal axes 115 of the sample containers 110 and/or parallel to one another. In the illustrated embodiment, the first and second reflecting surfaces 182, 202 of the plurality of reflecting surfaces 192 are each generally planar surfaces extending horizontally and perpendicular to the generally vertical longitudinal axis 115 of the sample containers 110 received in the housing 130.

Referring still to FIG. 6, in some embodiments the system of reflectors 168 also includes remote or secondary reflectors 212 forming remote or secondary reflecting surfaces 210, mounted within the heating chamber with the heating element but remote from the heating element.

As in the illustrated example, remote or secondary reflecting surfaces 210 may optionally be opposite reflecting surfaces, in that they are positioned opposite at least a portion of the heating element 170 across at least a portion of the sample container 110. With the heating element 170 positioned to a first lateral side 111 of a sample container 110, opposite reflecting surfaces 210 may be positioned opposite the heating element 170 across the sample container 110 to assist in reflecting radiation towards a side of the crucible portion 118 that is opposite to the side which the heating element 170 is positioned next to. The heating element 170 may direct radiation towards the crucible portion 118 at a heating angle, and the opposite reflecting surfaces 210 may direct radiation onto the crucible portions 118 at a reflection angle that is generally opposite in direction to the heating angle.

As illustrated in FIG. 6, the opposite reflecting surfaces 210 are arranged to redirect radiation 184 to an opposite region 211 of the crucible portion 118 that is across the sample container 110 from the heating element 170. The opposite region 211 may be on a bottom and/or lateral side of the crucible portion 118, as illustrated. For example, the heating element 170 may be positioned laterally outward of the first lateral side 111 of the sample container, and the opposite reflecting surface 210 may direct radiation towards a second lateral side 113 of the crucible portion 118 that is opposite the first lateral side 111.

The opposite reflecting surfaces 210 may be arranged to focus scattered infrared radiation back to the crucible portion 118. The opposite reflecting surfaces 210 may be generally planar surfaces, as illustrated. The opposite reflecting surfaces 210 are surfaces of opposite reflectors 212 mounted within the heating chamber 131 around the sample containers 110 when the sample containers 110 are received in the housing 130. The opposite reflectors 212 may each be a panel mounted to a wall of the heating compartment 132. For example, the reflector panels 212 may be mounted to the walls of the heating chamber 131 via threaded fasteners 213. Optionally, the reflector panels 212 may be mounted within the heating chamber 131 spaced from the walls of the heating chamber 131, as illustrated. An insulating gap 219 may extend between the reflector panels 212 and the walls of the heating compartment 132. The reflector panels 212 may be spaced from the walls of the heating chamber 131 by an air gap to, e.g., provide for improved heat management.

The illustrated example reflecting surfaces 210 include lateral reflecting surfaces 214 extending generally parallel to the heating element 170 and positioned to lateral sides of the sample containers 110 across from the heating element 170. The lateral reflecting surfaces 214 extend generally parallel to of the axes 115 of the sample containers 110 and to the axis 174 of the heating element 170. As illustrated, the lateral reflecting surfaces 214 may be the surfaces of laterally-positioned panels 215, such as polished surfaces of the panels 215.

The illustrated embodiment apparatus 100 also includes lower reflecting surfaces 216 extending generally parallel to the heating element 170 and positioned below the sample containers 110. The lower reflecting surfaces 216 are parallel to the axis 174 of the heating element 170, but at an angle to the axes 115 of the sample containers 110. Lower reflecting surfaces 216 may generally be angled downwardly and towards a heating element 170. The lower reflecting surfaces 216 may be angled downwardly and inwardly towards a central region of the heating compartment 132. The angle of the lower reflecting surface 216 may assist in redirecting radiation from the heating element 170 and/or facilitating drainage of liquid that may be in the heating chamber 131. The lower reflecting surfaces 216 may be surfaces of lower positioned panels 217, such as polished surfaces of the panels 217.

Optionally, the apparatus 100 includes a second cooling system 221 (FIG. 1) operable to cool the heating compartment 132. This second cooling system 221 may allow for a more rapid cooldown of the sample containers 110. Alternatively or additionally, removing heat from the crucible portions 118 of the sample containers 110 can help maintain the temperature of the acid or acid mixture below the boiling point in order to reduce vaporization of the acid or acid mixture. Less vaporization may reduce the amount of cooling needed for the cooling compartment 134. The second cooling system 221 may be operable to keep the acid from boiling. The second cooling system 221 may be operable to keep the acid at a temperature of below 300° C. (e.g., for sulpheric acid or phosphoric acid), below 100° C., below 25° C., or about 20-22° C. For example, the acid may have a boiling point near 100° C. (e.g., aqueous solutions or acids such as hydrochloric acid, nitric acid, and hydrofluoric acid). Removal of thermal energy from the acid can enhance sample digestion and can allow more input energy to further enhance or speed up the digestion process. In some examples, the increased input energy may be equivalent to 800° to 900° C. at the surface of the sample 400, which may provide faster sample decomposition or allow more complete digestion of difficult samples. Moreover, in some examples, the infrared heating mechanism may be capable of producing temperatures of more than 1000° C. (e.g., up to 200° C.) at the surface of the sample 120, which may further enhance sample decomposition.

The second cooling system 221 operable to cool the heating compartment 132 may be similar in some respects to the cooling system 139. Alternatively, in some embodiments, the second cooling system is or includes a fan operable to move air between the environment and a chamber of the heating compartment to cool the heating compartment. For example, the second cooling system may include a first fan 223 mounted in a wall of the heating compartment 132 through which a passage extends from the environment to the chamber 131 (e.g., to move air into the chamber 131), and may include a second fan mounted in a wall of the heating compartment 132 through which another passage extends from the environment to the chamber 131 (e.g., to move air out of the chamber 131).

Optionally, the second cooling system 221 operable to cool the heating compartment 132 is controlled by a second cooling controller, such as the heating controller that is operable to control the heating element 170, the cooling controller operable to control the cooling system 139, or a further separate controller. The second cooling controller may be operable to control the operation of the second cooling system by, e.g., controlling the state of the first and/or second fan (e.g., on, off, speed, air flow rate, etc.).

In some embodiments, the heating compartment 132 is a drained compartment, and includes at least one drainage passage leading from the chamber 131 to a collection area outside the apparatus 100.

Referring to FIG. 4, in the illustrated embodiment, the heating compartment 132 includes a drainage passage 280 leading from chamber 131 to an exterior of the apparatus 100. The drainage passage 180 includes an opening 182 between reflectors 212 mounted within the heating compartment 132, an opening 184 through the floor 108 of the heating chamber 131, and an opening 186 through the bottom panel 109 of the housing 130, with the passage 180 extending from the opening 182 to the opening 186 and through the opening 184. The illustrated example passage 180 is a gravity-driven passage, in that the passage 180 extends generally downward along its entire length. However, it will be understood that in other embodiments a drainage passage may extend downward along only a portion of its length or not at all and include a pump to provide for fluid movement (e.g., to pump from a collection region in the heating chamber 131 to an exterior of the housing 130).

Optionally, the heating element 170 may be moveable along the longitudinal axis 146 (e.g., on a track) parallel to a row of sample containers 110, and is moveable manually or by an actuator (e.g., a motor, automatically controller and/or toggle-initiated). For example, the heating element 170 may not be an elongated heating element, and may move along the axis 146 to positions adjacent multiple sample containers 110. However, as in the illustrated embodiment of FIGS. 1 to 6, an elongated heating element 170 may extend past multiple sample containers 110 without being moveable.

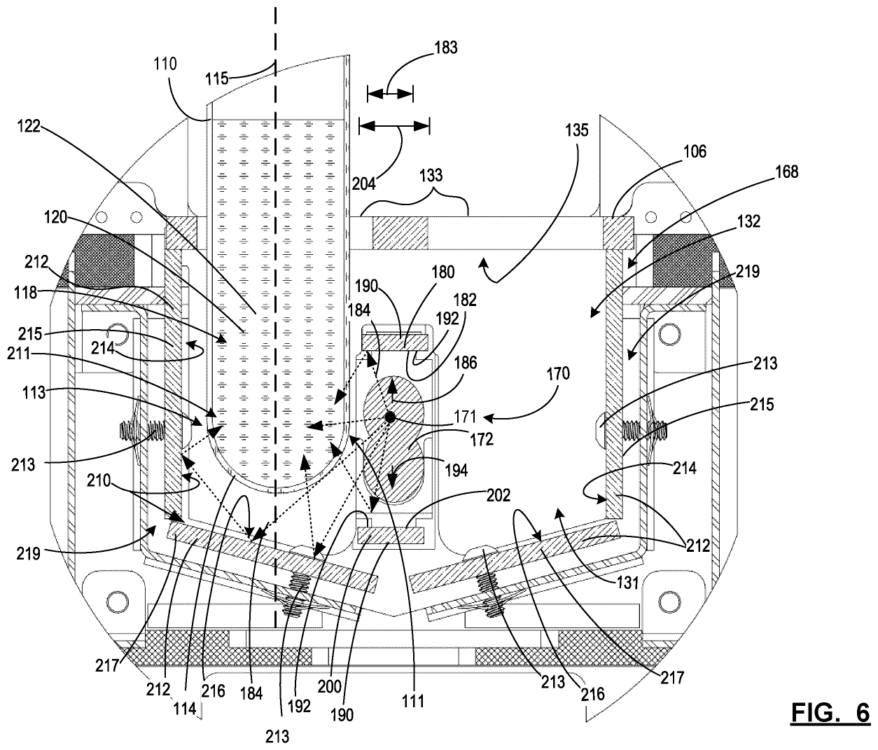

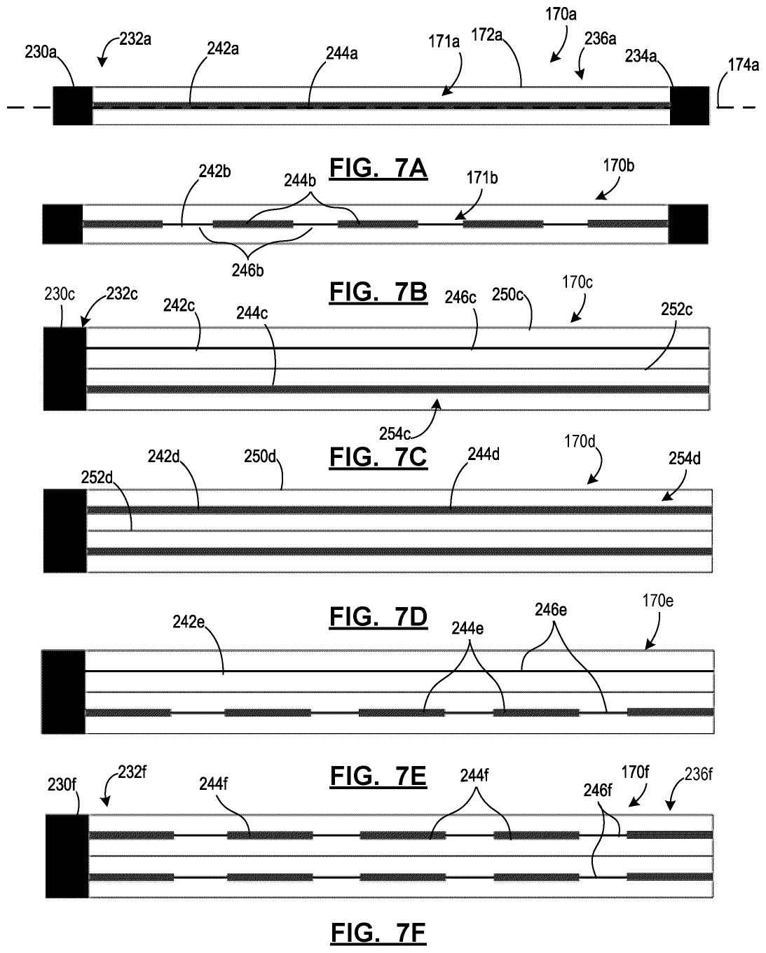

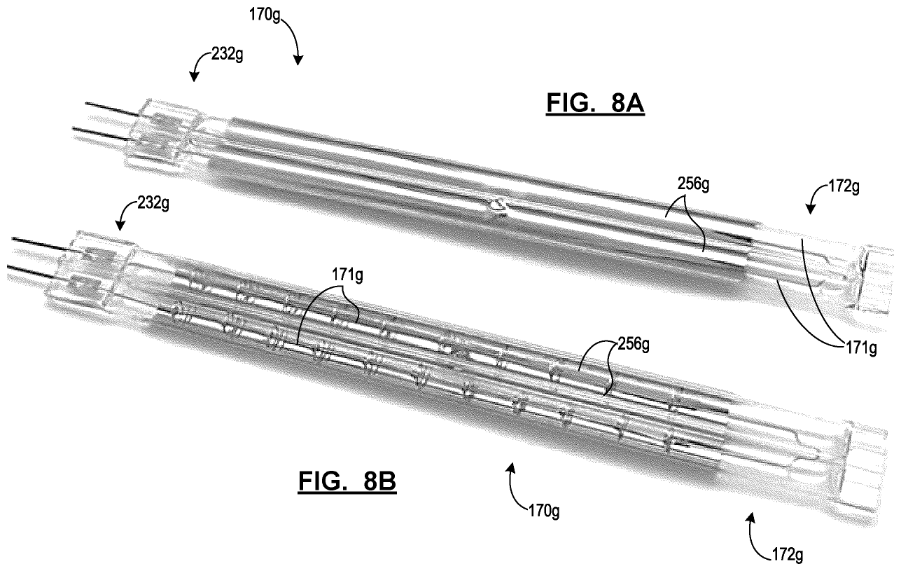

Referring now to FIGS. 7A to 7F, it will be understood that the apparatus 100 may include various heating elements 170. Illustrated in FIGS. 7A to 7F are example heating elements 170a to 170f. Apparatus 100 may include any of heating elements 170a to 170f in place of or in addition to heating element 170. The heating elements 170a to 170f are similar in some aspects to heating element 170 of FIGS. 1 to 6, and like features are indicated with like reference characters followed by a letter.

As illustrated in FIG. 7A, the body of a heating coil may be continuous. The heating element 170a of FIG. 7A includes a filament 171a and a heating tube 172a. The tube 172a is a generally linear tube enclosing the filament 171a. The filament 171a is joined to an electrical box to receive power through the electrical box (i.e., from a power source). The illustrated example filament 171a extends from a first electrical box 230a at a first end of the tube 232a to a second electrical box 234a at a second end of the tube 236a. A longitudinal axis 174a extends between the first and second ends 232a, 236a. The illustrated coil 171a includes a continuous body 242a with an emission portion 244a that extends continuously along the length of the body 242a. The emission portion 244a is operable to emit radiation (e.g., infrared radiation) when powered. In other words, the heating element 170a does not have non-emitting segments.

As illustrated in FIG. 7B, the body of a heating coil may be segmented. The heating element 170b of FIG. 7B includes a filament 171b that is a segmented heating coil. The filament 171b includes a segmented body 242b with a plurality of emissions portions 244b separated by non-emission portions 246b. The non-emission portions 246b pass power between the emission portions 244b but do not substantially emit the output radiation of the heating element 170b (e.g., infrared radiation). Non-emission portions 246b may be arranged to be positioned laterally beside space between sample containers 110 in a row 160. For example, the heating element 170b may be positioned laterally beside the row 160 and generally parallel to the row 160, with the emission portions 244b beside the sample containers 110 and the non-emission portions 246b between sample containers 110.

As illustrated in FIG. 7C, the body of a heating coil may form a loop that returns to an electrical box. The heating element 170c of FIG. 7C includes a body 242c that forms a loop that returns to an electrical box 230c at a first end 232c of a tube 172c. The illustrated example includes an emission portion 244c and a non-emission portion 246c generally parallel and of the same length as the emission portion 244c. The tube 172c includes a first tube member 250c and a second tube member 252c fused together along their length and fused at one side to form a common inner looped enclosure 254c containing the body 242c, including the emission portion 244c and the non-emission portion 246c to complete the circuit.

As illustrated in FIG. 7D, the looped body of a heating coil may emit over its entire extent. The heating element 170d of FIG. 7D includes a body 242d with an emission portion 244d that is generally continuous along the entire length of the body 242d through a common inner enclosure 254d formed by a first tube member 250d and a second tube member 252d fused together.

As illustrated in FIG. 7E, the looped body of a heated coil may be segmented over at least a portion of the body. The heating element 170e of FIG. 7E includes a body 242e with alternating emissions portions 244e and non-emission portions 246e over a first extent between the first and second ends 232e, 236e, and a non-emission portion 246e over a second extent returning to the electrical box 230e. Non-emission portions 246e may be arranged to be positioned laterally beside space between sample containers 110 in a row 160. For example, the heating element 170e may be positioned laterally beside the row 160 and generally parallel to the row 160, with the emission portions 244e beside the sample containers 110 and the non-emission portions 246e between sample containers 110.

As illustrated in FIG. 7F, the looped body of a heated coil may be segmented over generally the entire length of the body. The heating element 170f of FIG. 7F includes a body 242f with alternating emissions portions 244f and non-emission portions 246f over substantially the entire length of the body 242f. The emissions portions 244f of a segment between the first end 232f and the second end 236f may be lined up with the emissions portions 244f of a segment returning from the second end 236f to the first end 232f, as illustrated. Non-emission portions 246f may be arranged to be positioned laterally beside space between sample containers 110 in a row 160. For example, the heating element 170f may be positioned laterally beside the row 160 and generally parallel to the row 160, with the emission portions 244f beside the sample containers 110 and the non-emission portions 246f between sample containers 110.

Referring to FIGS. 8A and 8B, illustrated is another example heating element 170g. Apparatus 100 may include heating element 170g in place of or in addition to heating element 170. The heating element 170g is similar in some aspects to heating element 170 of FIGS. 1 to 6, and like features are indicated with like reference characters followed by the letter “g”.

As illustrated in FIGS. 8A and 8B, in some examples a heating element 170g includes a reflector 256g. The illustrated reflector 256g is a reflective layer on an interior surface of a tube 172g of the heating element 170g. The reflective layer may be, e.g., gold or ceramic. The example heating element 170g includes a looped filament 171g extending from and returning to a first end 232g that includes connectors to be joined to an electrical box.

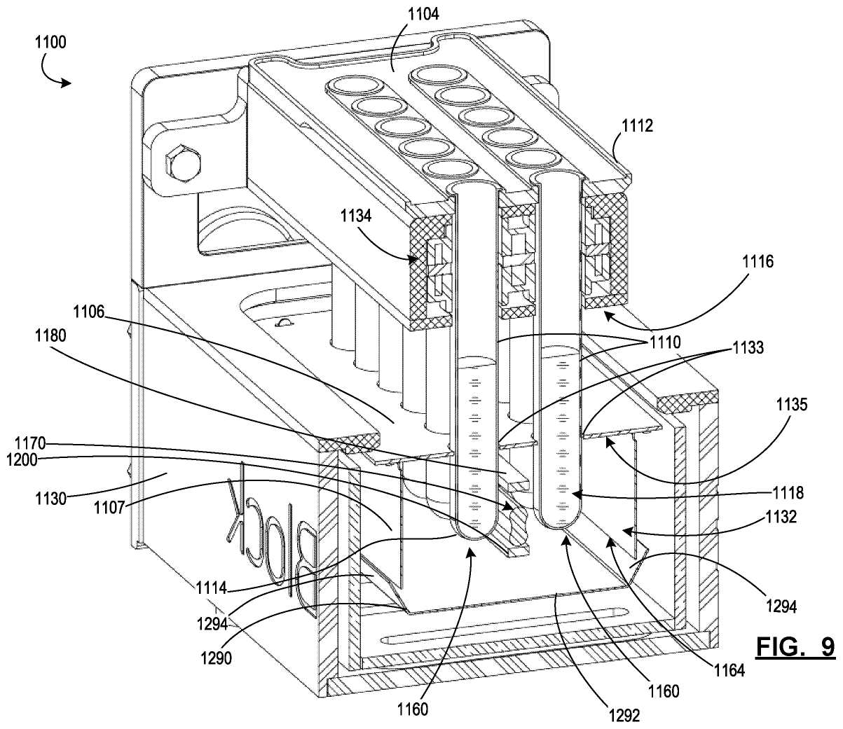

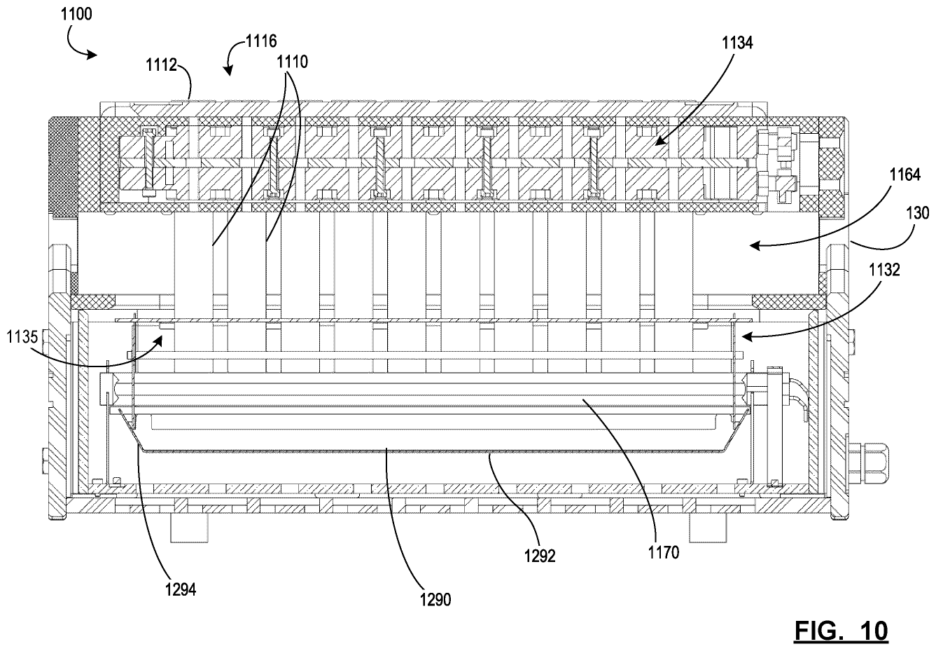

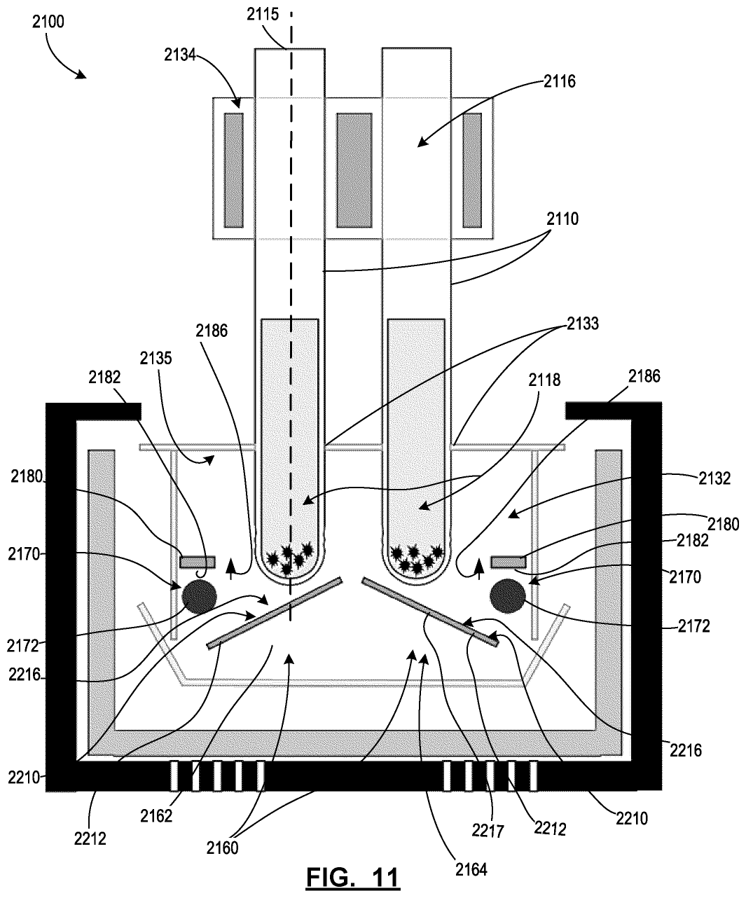

Referring now to FIGS. 9 and 10, illustrated is an example apparatus 1100 for preparing samples for chemical analysis. The exemplary apparatus 1100 is similar in some aspects to exemplary apparatus 100, and like features are indicated with like reference characters incremented by 1000.

The apparatus 1100 is shaped to receive a plurality of sample containers 1110. The sample containers 1110 are configured to hold samples to be prepared for chemical analysis, and include a crucible portion 1118 to hold a sample and an acid while the sample is heated to be dissolved in the acid. The example sample containers 1110 include the crucible portion 1118 at a closed second end 1114 and an expansion portion 1116 at an open first end 1112.

The apparatus 1100 includes a housing 1130. The housing 1130 is shaped to receive the plurality of sample containers 1110 with the crucible portions 1116 in a heating compartment 1132. The plurality of sample containers 1110 extend into the heating compartment through entrances 1133 at an entrance end 1135 of the heating compartment 1132.

In the exemplary embodiment, the housing 1130 also includes a cooling compartment 1134. The exemplary housing 1130 is shaped to receive the plurality of sample containers 1110 with the expansion portions 1116 in the cooling compartment 1134.

The housing 1130 is shaped to receive the crucible portions 1118 of the plurality of elongated sample containers 1110 arranged in a plurality of rows 1160 in the heating compartment 1132. The illustrated example includes a first row 1162 and a second row 1164. The rows 1160 may be parallel rows. The apparatus 1100 includes a heating element 1170 mounted within the heating compartment 1132 to heat the samples 1120 received in a sample containers 1110. The heating element 1170 may be arranged to simultaneously heat samples 1120 in more than one sample container 1110. In some embodiments, the heating element 1170 is an infrared heating element.

The bottom end of the heating compartment 1132 is closed to prevent drainage. In other words, the bottom end of the heating compartment 1132 is closed to collect liquid in the bottom end. In the illustrated example, a tray 1290 extends across the bottom end of the heating compartment. The tray 1290 closes the bottom of the heating compartment. The illustrated tray 1290 includes a closed base 1292 and sidewalls 1294 to form a collection region 1296 on the tray 1290. Optionally, the collection region 1296 may be pumped out.

Optionally, as illustrated in FIGS. 9 and 10, the apparatus 1100 does not include reflector panels mounted within the heating chamber (e.g., with insulation gaps between the panels and the walls of the heating chamber) in addition to the adjacent reflectors 1180, 1200. One or more walls of the heating chamber may form a reflector. For example, the sides 1294 and/or base 1292 may act as reflectors (e.g., bearing a reflecting surface directed towards the heating element). Optionally, sidewalls 1107 and/or top plate 1106 acts as a reflector (e.g., bears a reflecting surface directed towards the heating element). In other words, the apparatus 1100 does not include separate reflector panels forming remote or secondary reflectors (i.e., does not include panels corresponding to reflectors 212 of the example apparatus 100 of FIG. 6).

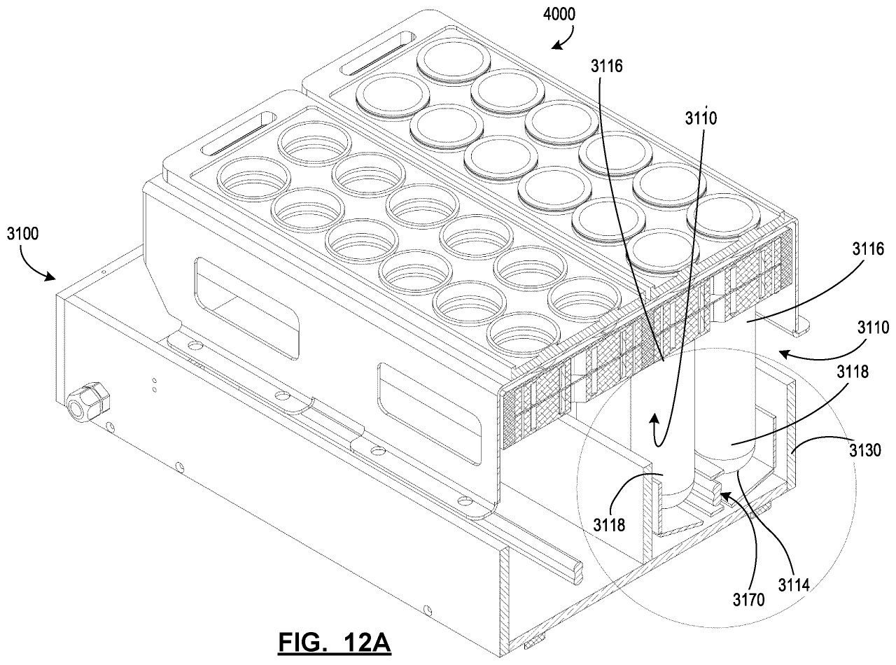

Referring now to FIG. 11, illustrated is an example apparatus 2100 for preparing samples for chemical analysis. The exemplary apparatus 2100 is similar in some aspects to exemplary apparatus 100, and like features are indicated with like reference characters incremented by 2000.

The apparatus 2100 is shaped to receive a plurality of sample containers 2110. The sample containers 2110 include a crucible portion 2118 to hold a sample and an acid while the sample is heated to be dissolved in the acid. The example sample containers 2110 include the crucible portion 2118 adjacent a closed second end 2114 and an expansion portion 2116 adjacent an open first end 2112.

The apparatus 2100 includes a housing 2130. The housing 2130 is shaped to receive the plurality of sample containers 2110 with the crucible portions 2116 in the heating compartment 2132. The plurality of sample containers 2110 extend into the heating compartment through entrances 2133 at an entrance end 2135 of the heating compartment 2132. In the exemplary embodiment, the housing 2130 also includes a cooling compartment 2134. The exemplary housing 2130 is shaped to receive the plurality of sample containers 2110 with the expansion portions 2116 in the cooling compartment 2134.

The housing 2130 is shaped to receive the crucible portions 2118 of the plurality of elongated sample containers 2110 arranged in a plurality of rows 2160 in the heating compartment 2132. The illustrated example includes a first row 2162 and a second row 2164. The rows 2160 may be parallel rows.

The apparatus 2100 may include a plurality of heating elements 2170, each with a tube 2172 containing a filament. The plurality of heating elements 2170 may be spaced from one another and generally parallel to one another, as illustrated. The plurality of heating elements 2170 may extend along opposite lateral sides of the heating compartment 2132, as illustrated. The sample containers 2110 may be arranged in a plurality of rows 2160 with the heating elements 2170 laterally out from between the rows 2160. In other words, the heating elements 2170 may be between the sample containers 2110 and the lateral walls of the heating compartment 2132. In some embodiments, the heating elements 2170 are infrared heating elements.

The apparatus 2100 may include a first reflector 2180 having a first reflector surface 2182. The first reflector 2180 is mounted within the heating compartment 2132 (i.e., not forming one of the walls of the heating compartment 2132), with the first reflector surface 2182 adjacent and above the heating element 2170. In other words, the first reflector surface 2182 is near the heating element 2170 with no other component between the heating element 2170 and the first reflector surface 2182. The exemplary first reflector surface 2182 is spaced from the heating element 2170. The first reflector 2180 may be spaced from one or more walls (e.g., ceiling and floor) of the heating compartment 2132, as illustrated.

The first reflector 2180 may be arranged in various positions to reflect radiation from the heating element 2170. The exemplary first reflector surface 2182 is positioned to reflect substantially all radiation that is emitted from the heating element 2170 in a first direction 2186 that is towards the entrance end 2135 of the heating compartment 2132 and parallel to the longitudinal axes 2115 of the sample containers 2110. In some embodiments, as illustrated, the first reflector 2180 is positioned with the first reflector surface 2182 nearer than the heating element 2170 to the entrances 2133 and/or entrance end 2135 through which the sample containers 2110 extend into the heating compartment 2132 when the sample containers 2110 are received in the housing 2130.

The first reflector surface 2182 may be generally perpendicular to the axes 2115 of the sample containers 2110. As in the exemplary embodiment, the first reflector 2180 may be the only adjacent reflector (e.g., positioned directly above or below the heating element 2170 and extending generally perpendicular to the axes 2115 of the sample containers 2110). The illustrated first reflector 2180 is positioned directly above the heating element 2170 and extending generally perpendicular to the axes 2115 of the sample containers 2110.

The apparatus 2100 also includes remote reflecting surfaces 2210, mounted within the heat heating chamber with the heating element but remote from the heating element. The remote reflecting surfaces 2210 may be arranged to focus scattered infrared radiation back to the crucible portions 2118. The remote reflecting surfaces 2210 may be generally planar surfaces, as illustrated. The remote reflecting surfaces 2210 are surfaces of remote reflectors 2212 mounted within the heating chamber 2131 around the sample containers 2110 when the sample containers 2110 are received in the housing 2130. The remote reflectors 2212 may each be a panel mounted to a wall of the heating compartment 2132. Optionally, the reflector panels 2212 may be mounted within the heating chamber 2131 spaced from the walls of the heating chamber 2131, as illustrated. The reflector panels 2212 may be spaced from the walls of the heating chamber 2131 by an air gap to, e.g., provide for improved heat management.

The illustrated example reflecting surfaces 2210 include lower reflecting surfaces 2216 extending generally parallel to the heating elements 2170 and positioned below the sample containers 2110. The lower reflecting surfaces 2216 are parallel to the longitudinal axis of the heating element 2170, but at an angle to the axes 2115 of the sample containers 2110. Unlike the surface 216 of FIG. 6, the lower reflecting surfaces 2216 may be angled downwardly and outwardly towards a side regions of the heating compartment 2132. Lower reflecting surfaces 2216 may generally be angled downwardly and towards a heating element 2170. The angle of the lower reflecting surface 2216 may assist in redirecting radiation from the heating element 2170 and/or facilitating drainage of liquid that may be in the heating chamber 2131. The lower reflecting surfaces 2216 may be surfaces of lower positioned panels 2217, such as polished surfaces of the panels 2217.

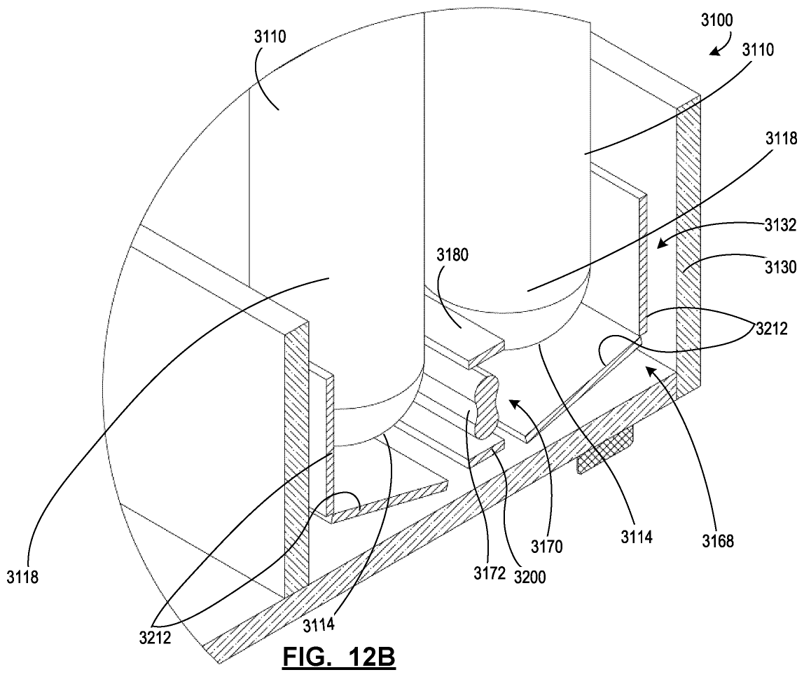

Referring now to FIGS. 12A and 12B, illustrated is an example apparatus 3100 for preparing samples for chemical analysis. The exemplary apparatus 3100 is similar in some aspects to exemplary apparatus 100, and like features are indicated with like reference characters incremented by 3000.

The apparatus 3100 is shaped to receive a plurality of sample containers 3110. The sample containers 3110 include a crucible portion 3118 to hold a sample and an acid while the sample is heated to be dissolved in the acid. The example sample containers 3110 include the crucible portion 3118 adjacent a closed second end 3114 and an expansion portion 3116 remote from the crucible portion 3118.

The apparatus 3100 includes a housing 3130. The housing 3130 is shaped to receive the plurality of sample containers 3110 with the crucible portions 3118 in a heating compartment 3132. In the exemplary embodiment, the housing 3130 does not include a cooling compartment. As exemplified in FIG. 12A, a separate apparatus 4000 may provide a cooling function. The separate apparatus 4000 may be, e.g., removably attached to the housing 3130 or positionable adjacent (i.e., above) the housing 3130. The apparatus 4000 is illustrated positioned above the housing 3130 in FIG. 12A.

Referring still to FIGS. 12A and 12B, the exemplary housing 3130 is shaped to receive the plurality of sample containers 3110 with the expansion portions 3116 remote from the heating compartment 3132. The apparatus 3100 includes a heating element 3170, with a tube 3172 containing a filament. The heating element 3170 is mounted in the heating compartment 3132 generally parallel to each of a plurality of rows 3160 of crucible portions 3118. In some embodiments, the heating element 3170 is an infrared heating element.

The apparatus 3100 includes a system of reflectors 3168. The system of reflectors 3168 includes a first adjacent reflector 3180, a second adjacent reflector 3200, and remote reflectors 3212.

While the above description provides examples of one or more apparatus, methods, or systems, it will be appreciated that other apparatus, methods, or systems may be within the scope of the claims as interpreted by one of skill in the art.

1. An apparatus for preparing samples for chemical analysis, comprising:
a) a housing for housing a plurality of elongated sample containers, each of the sample containers having a crucible portion adjacent a closed end and an expansion portion remote from the closed end, the housing having a plurality of receptacles, each of the receptacles being shaped to receive one of the plurality of elongated sample containers such that the crucible portion of the one of the plurality of elongated sample containers is received in a heating compartment of the housing, the plurality of receptacles arranged in a plurality of rows of receptacles such that the plurality of crucible portions of the plurality of sample containers are arranged in a plurality of rows of crucible portions in the heating compartment when the plurality of sample containers are received in the housing
b) an elongated heating element mounted within the heating compartment between and along a first row and a second row of the plurality of rows of receptacles such that the elongated heating element is arranged between and along a first row and a second row of the plurality of rows of crucible portions when the plurality of sample containers are received in the housing; and
c) a system of reflectors mounted within the heating compartment and arranged to reflect infrared radiation that is emitted from the elongated heating element away from the crucible portions back towards the crucible portions when the plurality of sample containers are received in the housing.

2. The apparatus of claim 1, wherein the first row and the second row of the plurality of receptacles are parallel, and the elongated heating element is mounted between the first row and the second row such that a lateral projection of each crucible portion of the first row and the second row passes through the elongated heating element when the plurality of sample containers are received in the housing.

3. The apparatus of claim 1, wherein the system of reflectors includes a plurality of adjacent reflectors, each adjacent reflector mounted in the heating compartment with an adjacent reflector surface adjacent the heating element, the plurality of adjacent reflector surfaces positioned facing one another across the elongated heating element.

4. The apparatus of claim 3, wherein the plurality of adjacent reflector surfaces are each generally planar surfaces and are each elongated reflecting surface extending generally parallel to the elongated heating element and generally perpendicular to longitudinal axes of the plurality of sample containers when the plurality of sample containers are received in the housing.

5. The apparatus of claim 1, wherein the system of reflectors includes an opposite reflector with an opposite reflecting surface, the opposite reflector mounted within the heating compartment with the opposite reflecting surface positioned such that when a group of the plurality of crucible portions are received in the heating compartment the opposite reflecting surface is opposite the heating element across the crucible portions of the group and directed at the heating element such that the opposite reflecting surface directs radiation towards a second lateral side of each crucible portion of the group, the second lateral side being opposite a first lateral side directed towards the elongated heating element.

6. An apparatus for preparing samples for chemical analysis, comprising:
a) a housing for housing a plurality of elongated sample containers, each of the sample containers having a crucible portion adjacent a closed end and an expansion portion remote from the closed end, the housing having a plurality of receptacles, each receptacle being shaped to receive one of the plurality of sample containers such that the crucible portion of the one of the plurality of sample containers is received in a heating compartment of the housing, the plurality of receptacles arranged in a plurality of rows of receptacles such that the plurality of crucible portions of the plurality of sample containers are arranged in a plurality of rows of crucible portions in the heating compartment when the plurality of sample containers are received in the housing;
b) an elongated infrared heating element mounted within the heating compartment between and along a first row and a second row of the plurality of rows of receptacles such that the elongated heating element is arranged between and along a first row and a second row of the plurality of rows of crucible portions when the plurality of sample containers are received in the housing;
c) a first adjacent reflector with a first elongated reflecting surface extending generally parallel to the elongated heating element, the first adjacent reflector mounted within the heating compartment with the first reflecting surface directed at the heating element; and
d) a second adjacent reflector with a second elongated reflecting surface extending generally parallel to the elongated heating element, the second adjacent reflector mounted within the heating compartment with the second reflecting surface directed at the heating element and generally facing the first reflecting surface across the heating element.

7. The apparatus of claim 6, wherein each receptacle is shaped to receive the one of the plurality of sample containers such that the expansion portion is received in a cooling compartment of the housing, the cooling compartment separated from the heating compartment by an insulating region, and the apparatus further comprising a cooling system arranged to cool the expansion portions in the cooling compartment while the plurality of sample containers are received in the housing.

8. The apparatus of claim 7, wherein the first reflecting surface and the second reflecting surface are each generally planar surfaces, and the first and second reflecting surfaces are generally parallel to one another and each extend generally perpendicular to a longitudinal axis of a sample container of the plurality of sample containers when the sample container is received in the housing.

9. The apparatus of claim 8, wherein the longitudinal axis is generally vertical and the second reflecting surface is a lower surface and the first reflecting surface is an upper surface overlying the second reflecting surface.

10. The apparatus of claim 6, wherein the first reflector is a first reflector panel adjacent and spaced from the heating element and the second reflector is a second reflector panel adjacent and spaced from the heating element, each of the first and second reflector panels mounted in the heating compartment spaced from walls of the heating compartment.

11. The apparatus of claim 6, wherein the housing is shaped to receive the plurality of sample containers in a plurality of rows that each extend generally parallel to the heating element, and wherein the heating element extends between a first row of the plurality of rows and a second row of the plurality of rows when the plurality of sample containers are received in the housing.

12. The apparatus of claim 6, further comprising an opposite reflector with an opposite reflecting surface, the opposite reflector mounted within the heating compartment with the opposite reflecting surface positioned such that, when the plurality of sample containers are received in the heating compartment, the heating element is positioned laterally outward from a first lateral side of each of the crucible portions of a group of sample containers of the plurality of sample containers and extending past each of the crucible portions of the group of sample containers, and the opposite reflecting surface is opposite the heating element across the crucible portions of the group of sample containers and directed at the heating element such that the opposite reflecting surface directs radiation towards a second lateral side of each crucible portion of the group of sample containers, the second lateral side being opposite the first lateral side.

13. An apparatus for preparing samples for chemical analysis, comprising:
a) a housing for housing a plurality of elongated sample containers, each of the sample containers having a crucible portion adjacent a closed distal end and an expansion portion remote from the closed end, the housing having a plurality of receptacles, each receptacle being shaped to receive one of the plurality of sample containers such that the crucible portion of the one of the plurality of sample containers is received in a heating compartment of the housing;
b) an elongated infrared heating element mounted within the heating compartment and arranged to simultaneously heat samples in each of the crucible portions while the plurality of sample containers are received in the housing, the elongated heating element positioned laterally outward from a first lateral side of each of the crucible portions and extending past each of the plurality of crucible portions when the plurality of sample containers are received in the housing;
c) a remote reflector with a remote reflecting surface, the remote reflector mounted within the heating compartment with the remote reflecting surface positioned such that when the plurality of crucible portions are received in the heating compartment the remote reflecting surface is remote from the heating element and adjacent a second lateral side opposite the first lateral side of each crucible portion of the group.

14. The apparatus of claim 13, wherein each receptacle is shaped to receive the one of the plurality of sample containers such that the expansion portion is received in a cooling compartment of the housing, the cooling compartment separated from the heating compartment by an insulating region, and the apparatus further comprising a cooling system arranged to cool the expansion portions in the cooling compartment while the plurality of sample containers are received in the housing.

15. The apparatus of claim 13, wherein the remote reflector is a remote reflector panel mounted in the heating compartment spaced from the sample container, and spaced from walls of the heating compartment by an insulating gap.

16. The apparatus of claim 13, wherein the remote reflecting surface is a generally planar surface.

17. The apparatus of claim 13, wherein the plurality of receptacles are arranged in a plurality of rows of receptacles such that the plurality of crucible portions of the plurality of sample containers are arranged in a plurality of parallel rows of crucible portions in the heating compartment when the plurality of sample containers are received in the housing with the elongated heating element received between and along the plurality of rows of crucible portions, and the apparatus includes at least two remote reflectors, each remote reflector mounted within the heating compartment with the remote reflecting surface positioned opposite the heating element across the crucible portions of a group of sample containers of the plurality of sample containers and directed at the heating element.

18. The apparatus of claim 17, wherein, when the plurality of sample containers are received in the housing, the heating element extends between a first row of the plurality of rows of crucible portions and a second row of the plurality of rows of crucible portions, and the at least two remote reflectors includes a pair of remote reflecting surfaces positioned with the first and second rows extending between the pair of surfaces.

19. The apparatus of claim 13, further comprising a pair of adjacent reflectors each with an adjacent reflecting surface, the pair of adjacent reflectors each mounted within the heating compartment with the corresponding adjacent reflecting surface directed at the heating element and positioned facing the other adjacent reflecting surface across the heating element.

20. The apparatus of claim 19, wherein the housing has a vertical axis and the housing is shaped to receive the plurality of elongated sample containers each in a generally vertical orientation, and the pair of adjacent reflectors includes a lower reflector below the heating element and an upper reflector above the heating element and overlying the lower reflector.
